(19) United States
(12) Patent Application Publication
(10) Pub. No.: US 2025/0077919 A1
(43) Pub. Date: Mar. 6, 2025

(54) COMPUTER-READABLE RECORDING MEDIUM STORING OPERATION PROGRAM, OPERATION METHOD, AND INFORMATION PROCESSING APPARATUS

(71) Applicant: Fujitsu Limited, Kawasaki-shi (JP)

(72) Inventor: Akito MARUO, Atsugi (JP)

(73) Assignee: Fujitsu Limited, Kawasaki-shi (JP)

(21) Appl. No.: 18/777,702

(22) Filed: Jul. 19, 2024

(30) Foreign Application Priority Data
Aug. 31, 2023 (JP) 2023-140967

(51) Int. Cl. G06N 7/01; G06N 3/126

(52) U.S. Cl. CPC G06N 7/01; G06N 3/126

(57) ABSTRACT

A medium storing an operation program for causing a computer to perform processing including: in repeatedly executing operation processing including creating an Ising model based on a learning data group, searching for a first set number of first recommended points for the Ising model, searching for a second set number of second recommended points for the learning data group by a genetic algorithm, and adding the first recommended points and first evaluation values of the first recommended points and the second recommended points and second evaluation values of the second recommended points to the learning data group as learning data, generating types of a sequence as an initial point of each piece of learning data of the learning data group; and when the second recommended points are searched for, applying the genetic algorithm to a form of the sequence.

### CROSS-REFERENCE TO RELATED APPLICATION

This application is based upon and claims the benefit of priority of the prior Japanese Patent Application No. 2023-140967, filed on Aug. 31, 2023, the entire contents of which are incorporated herein by reference.

### FIELD

The embodiment discussed herein is related to a computer-readable recording medium storing an operation program, an operation method, and an information processing apparatus.

### BACKGROUND

A technique has been disclosed in which optimization is performed by performing sampling of binary variables.

Japanese Laid-open Patent Publication No. 2022-190752, Japanese Laid-open Patent Publication No. 2021-33544, and Japanese Laid-open Patent Publication No. 2022-45870 are disclosed as related art.

### SUMMARY

According to an aspect of the embodiments, there is provided a non-transitory computer-readable recording medium storing an operation program for causing a computer to perform processing including: in repeatedly executing operation processing including creating an Ising model based on a learning data group, searching for a first set number of first recommended points for the Ising model, searching for a second set number of second recommended points for the learning data group by a genetic algorithm, and adding the first recommended points and first evaluation values of the first recommended points and the second recommended points and second evaluation values of the second recommended points to the learning data group as learning data, generating a plurality of types of a sequence as an initial point of each piece of learning data of the learning data group; when the first recommended points are searched for, searching for the first recommended points after a matrix of i and j is converted into a bit array of i and j in which a value that corresponds to the sequence is 1 and other values are 0 when an index of a variable in the sequence is i and an index that represents a type of the variable is j for the each piece of learning data, by providing a constraint that only one of variables of each row is 1 and only one of variables of each column is 1 in the matrix; and when the second recommended points are searched for, applying the genetic algorithm to a form of the sequence.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram exemplifying a search for a solution in a QUBO format;

FIG. 2 is a diagram illustrating evaluation values for movies watched by many users;

FIG. 3 is a flowchart illustrating an execution procedure in a sampling technique using a model in the QUBO format;

FIG. 4 is a diagram for describing an overview of a 2way1hot constraint;

FIG. 5A is a block diagram exemplifying an overall configuration of an information processing apparatus, and FIG. 5B is a block diagram exemplifying a hardware configuration of the information processing apparatus;

FIG. 6 is a flowchart illustrating an example of the operation of the information processing apparatus;

FIG. 7 is a flowchart illustrating the details of step S11;

FIG. 8 is a diagram illustrating one example of step S21 and step S22;

FIG. 9 is a diagram illustrating another example of step S21 and step S22;

FIG. 10 is a flowchart illustrating the details of step S13;

FIG. 11A is a diagram exemplifying crossover, and FIG. 11B is a diagram exemplifying mutation;

FIG. 12 is a diagram in which the processing of an embodiment is organized;

FIG. 13 is a diagram exemplifying a test problem;

FIG. 14 is a diagram illustrating the best values found in a search; and

FIG. 15A is a diagram illustrating the details of a result of a method using only FM-DA, and FIG. 15B is a diagram illustrating the details of a result of the method of the embodiment.

### DESCRIPTION OF EMBODIMENTS

For example, since a sampling technique using an Ising model in a quadratic unconstrained binary optimization (QUBO) format is a method of sequentially sampling recommended points in a model, there is a possibility that a sampling region is limited. Therefore, as a result, there is a possibility that the number of times of sampling increases.

In one aspect, an object of the present disclosure is to provide an operation program, an operation method, and an information processing apparatus that may reduce the number of times of sampling.

As a technique of searching for a good solution with a high evaluation value from a large number of combinations, order, or the like, a sampling technique of binary variables is used. As the sampling technique of binary variables, there are a sampling technique of randomly performing sampling, a sampling technique using an Ising model in the QUBO format, and the like.

The sampling technique of randomly performing sampling may easily perform sampling, but has a disadvantage that sampling efficiency is poor and the number of times of sampling increases in order to obtain a good solution with high accuracy.

For example, as the sampling technique using a model in the QUBO format, there are factorization machine with quantum annealing (FMQA) and the like. FMQA is a method in which quantum annealing (QA) and factorization machine (FM) (machine learning method) are combined. In the method of FMQA, an FM model in the QUBO format is created from learning data, a good solution is obtained by QA, an evaluation value of the good solution is analyzed by a solver, a result is added to the learning data, and sampling is performed interactively. Further, as the sampling technique using a model in the QUBO format, there is an FMDA technique. FMDA is obtained by replacing the QA portion of FMQA with a digital annealer (DA).

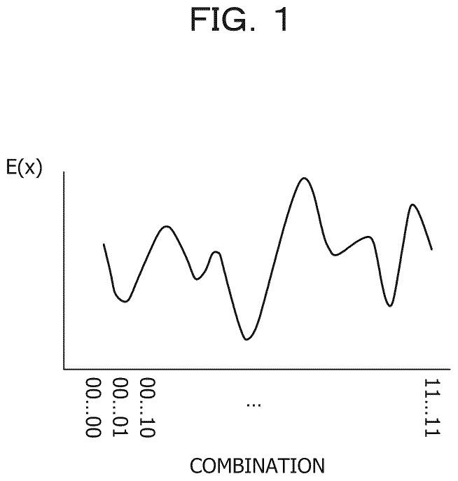

The QUBO format is quadratic unconstrained binary optimization, and is a format that is free from a quadratic constraint and enables binary optimization. For example, the QUBO format may be expressed as in the following formula. xᵢ=0 or 1 (i=1, . . . , N). Wᵢⱼ is a coupling coefficient between xᵢ and xⱼ. bᵢ is a bias coefficient of xᵢ. The first term on the right side is a quadratic term and represents interaction. The second term on the right side is a linear term and represents a bias effect. The third term on the right side is a constant term. In the QUBO format, as exemplified in FIG. 1, good solution x for minimizing E(x) representing energy is searched for in accordance with the following formula.

$$E ( x ) = - {\sum }_{i , j} {W}_{ij} {x}_{i} {x}_{j} - {\sum }_{i} {b}_{i} {x}_{i} + const .$$

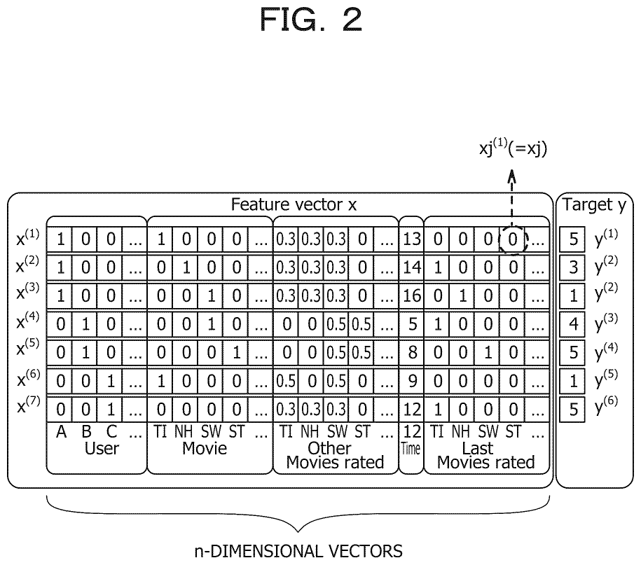

As an example of the sampling technique using a model in the QUBO format, an overview of FMDA will be described. As an example, FIG. 2 illustrates evaluation values for movies watched by many users. These evaluation values are n-dimensional vectors. First, a model in the QUBO format for representing interaction is created from these evaluation values. A model in the QUBO format may be expressed as in the following formula.

$$\hat{y} ( {x}^{( k )} ) := {w}_{0} + {{\sum }^{n}}_{i = 1} {w}_{i} {x}_{i}^{( k )} + {{\sum }^{n}}_{i = 1} {{\sum }^{n}}_{j = i + 1} 〈 {v}_{i} , {v}_{j} 〉 {x}_{i}^{( k )} {x}_{j}^{( k )}$$

In the above formula, w₀, wᵢ, vᵢ, and vⱼ are coefficients to be learned. This machine learning model is a model that is strong against a sparse data set. Since this model is in the QUBO format, a model in the QUBO format may be automatically generated by learning FM.

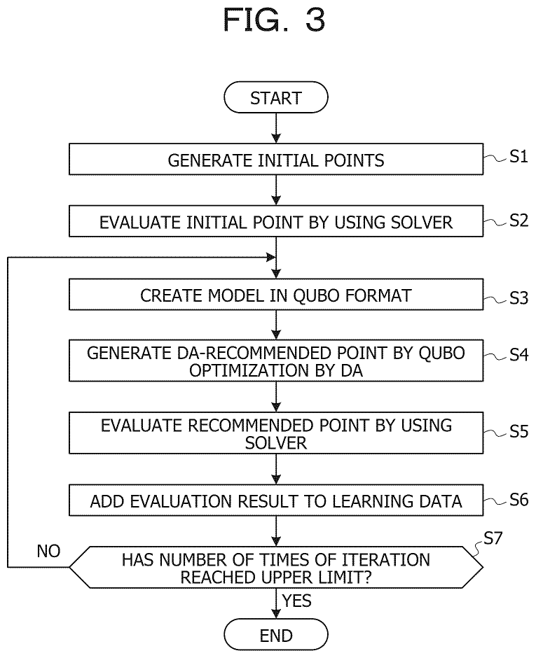

FIG. 3 is a flowchart illustrating an execution procedure in the sampling technique using a model in the QUBO format. As exemplified in FIG. 3, first, a learning data group is generated by randomly generating pieces of learning data (initial points) (step S1). The number of pieces of learning data to be generated is determined by the setting of a user.

Next, an evaluation value of an initial point is calculated by using a solver (step S2). An evaluation value is an indicator for determining whether an initial point or a recommended point to be described later is good. By the above-described steps, an initial learning data group in which an initial point and an evaluation value form a set is generated.

Next, a model in the QUBO format is created by generating FM from the learning data group (step S3). Since FM is in the QUBO format, generation of FM is equivalent to generation of a model in the QUBO format. Any other machine learning model may be used as long as a model in the QUBO format may be generated.

Next, optimization of the created model in the QUBO format is performed by using DA, and a good solution with the best evaluation value (DA-recommended point) is generated (step S4).

Next, an evaluation value of the DA-recommended point is calculated by using the solver (step S5).

Next, an evaluation result (a recommended point and evaluation value set) is added to the learning data group as learning data (step S6).

Next, it is determined whether the number of times of iteration has reached an upper limit (step S7). When “No” is determined in step S7, the processing is executed again from step S3. Accordingly, step S3 to step S6 are repeated until an end condition is satisfied. When “Yes” is determined in step S7, the execution of the flowchart ends. As the end condition, a condition such as a case where an amount of change in objective function is less than a threshold for a certain period of time may be used.

By the above-described procedure, the learning data group is updated, and an optimal solution may be obtained.

Although FMDA has been described in FIG. 3, the DA portion of FMDA may be replaced with QA, and any other method may be used as long as it is an Ising machine capable of solving QUBO. Besides using an Ising machine dedicated for solving QUBO, an Ising model may be solved by using software.

Since the sampling technique using a model in the QUBO format is a method of sequentially sampling recommended points in a model, there is a possibility that a sampling region is limited. In the sampling technique using a model in the QUBO format, sampling performance depends on a learning data group for model generation. Since FM is a quadratic model, there is a possibility that a problem may not be fully expressed. In a case where a plurality of recommendation methods is used, it is difficult to adjust the number of recommendations. From the above, the number of times of sampling increases in order to increase the accuracy of searching for an optimal solution.

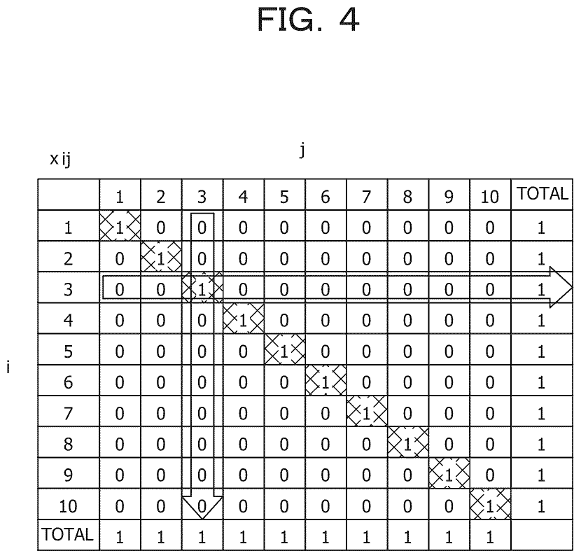

Accordingly, it is conceivable that search efficiency is improved by using a penalty method. The penalty method is a method of obtaining an approximate solution while avoiding a constraint violation by imposing a numerical penalty (deteriorating an objective function) when a constraint condition is violated in a problem having the constraint condition. As an example, it is conceivable that a 2way1hot constraint is used for generation of initial points. FIG. 4 is a diagram for describing an overview of the 2way1hot constraint. As exemplified in FIG. 4, in the 2way1hot constraint, in a case where xᵢ and xⱼ are represented as a matrix, xᵢ and xⱼ are set such that only one state variable among the variables of each row is 1 and only one state variable among the variables of each column is 1.

However, when the 2way1hot constraint is used, since a solution that violates the 2way1hot constraint is generated during a search for a solution, there is a possibility that the efficiency of searching for a solution deteriorates. As a result, there is a possibility that the solution to be searched for falls into a local solution. Accordingly, in the following embodiment, description will be given for an example in which the number of times of sampling may be reduced while avoiding a local solution even when the 2way1hot constraint is applied.

### First Embodiment

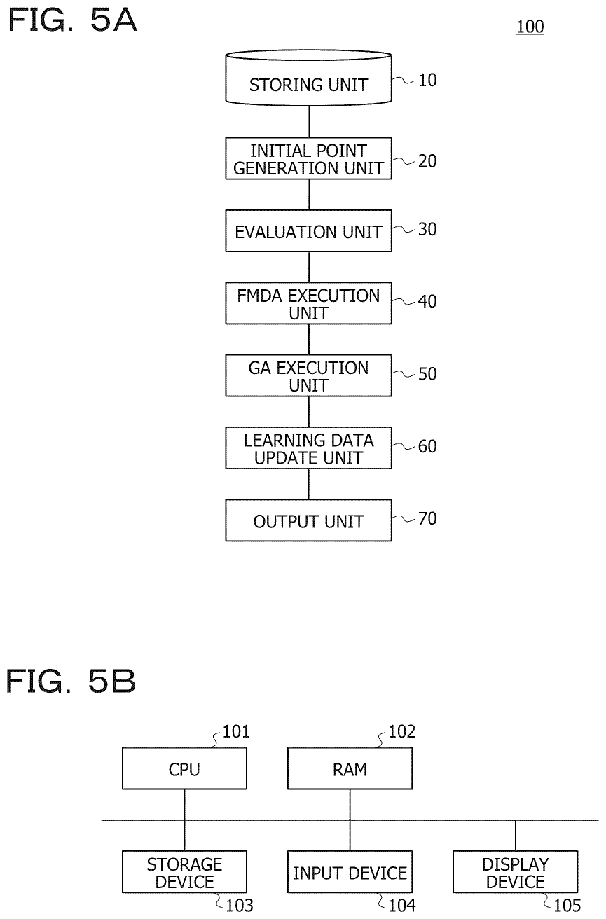

FIG. 5A is a block diagram exemplifying an overall configuration of an information processing apparatus 100. As exemplified in FIG. 5A, the information processing apparatus 100 includes a storing unit 10, an initial point generation unit 20, an evaluation unit 30, an FMDA execution unit 40, a genetic algorithm (GA) execution unit 50, a learning data update unit 60, an output unit 70, and the like.

FIG. 5B is a block diagram illustrating a hardware configuration of the information processing apparatus 100. As exemplified in FIG. 5B, the information processing apparatus 100 includes a central processing unit (CPU) 101, a random-access memory (RAM) 102, a storage device 103, an input device 104, a display device 105, and the like.

The CPU 101 is a central processing unit. The CPU 101 includes one or more cores. The RAM 102 is a volatile memory that temporarily stores a program executed by the CPU 101, data processed by the CPU 101, and the like. The storage device 103 is a nonvolatile storage device. As the storage device 103, for example, a read-only memory (ROM), a solid-state drive (SSD) such as a flash memory, a hard disk to be driven by a hard disk drive, or the like may be used. The storage device 103 stores an operation program. The input device 104 is an input device such as a keyboard or a mouse. The display device 105 is a display device such as a liquid crystal display (LCD). By the CPU 101 executing the operation program, the storing unit 10, the initial point generation unit 20, the evaluation unit 30, the FMDA execution unit 40, the GA execution unit 50, the learning data update unit 60, the output unit 70, and the like are realized. Hardware such as dedicated circuits may be used as the storing unit 10, the initial point generation unit 20, the evaluation unit 30, the FMDA execution unit 40, the GA execution unit 50, the learning data update unit 60, the output unit 70, and the like.

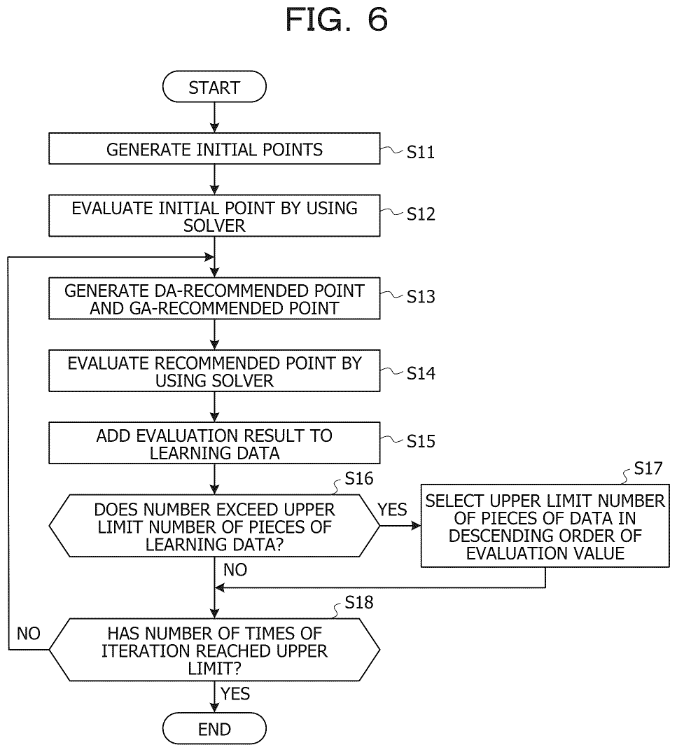

FIG. 6 is a flowchart illustrating an example of the operation of the information processing apparatus 100. As exemplified in FIG. 6, the initial point generation unit 20 generates a learning data group by generating initial points of learning data (step S11). The number of pieces of learning data to be generated is determined by the setting of a user.

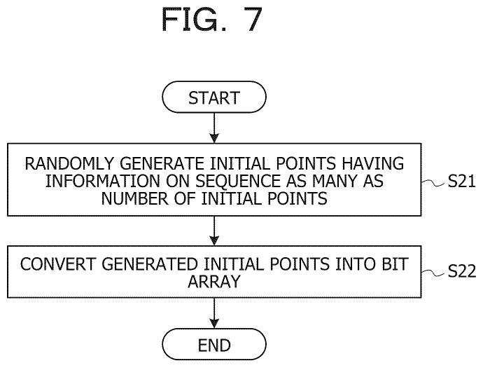

FIG. 7 is a flowchart illustrating the details of step S11. As exemplified in FIG. 7, the initial point generation unit 20 randomly generates initial points having information on a sequence as many as the number of initial points (step S21). The sequences are different from each other. Next, the initial point generation unit 20 converts the initial points generated in step S21 into a bit array (step S22). After that, the flowchart of FIG. 7 ends.

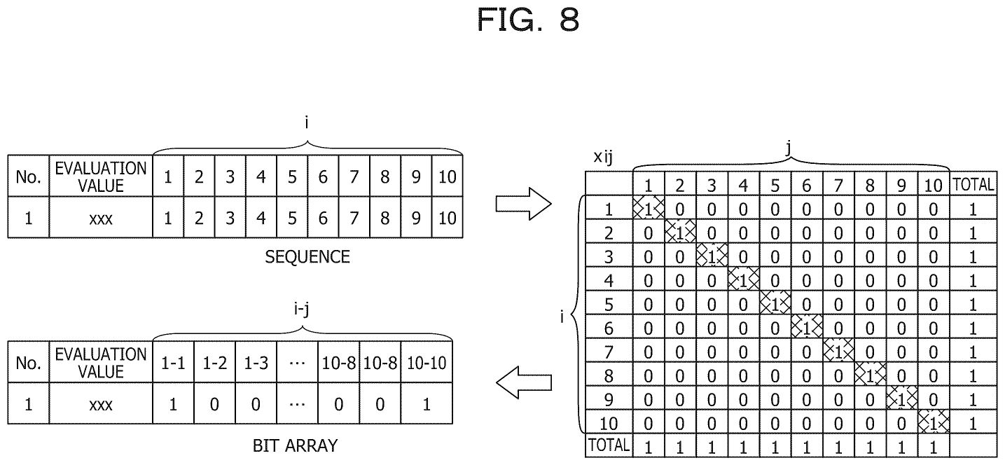

FIG. 8 is a diagram illustrating one example of step S21 and step S22. As exemplified in the upper left diagram of FIG. 8, one initial point is generated in the form of a sequence. “i” is an index of a variable in the sequence. In this case, “j” is an index representing the type of a variable. In the example of the upper left diagram of FIG. 8, a sequence is generated in which “j” is arranged in order from 1 to 10 when “i” is arranged in order from 1 to 10. This sequence is converted into a bit matrix as in the right diagram of FIG. 8. In the example of FIG. 8, “1” when i=j, and “0” when i≠j. As in the lower left diagram, the obtained bit matrix is converted into a bit array.

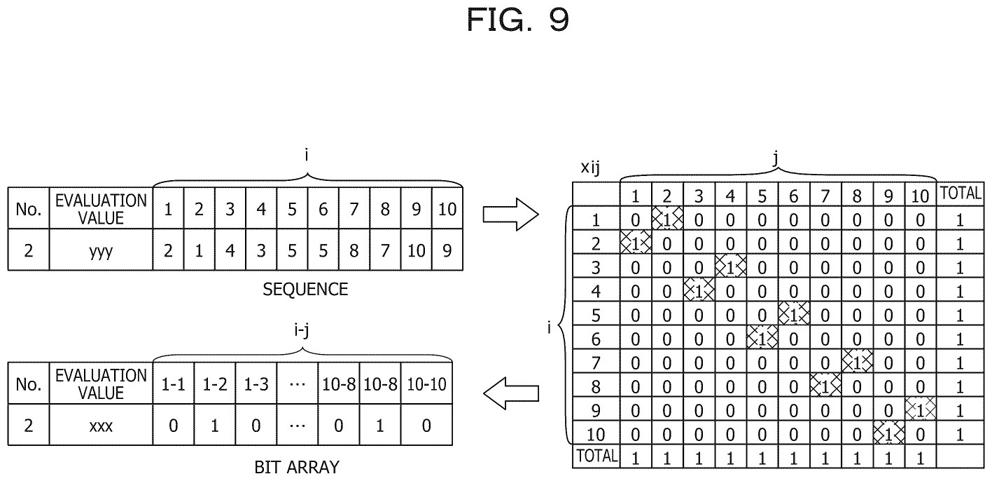

FIG. 9 is a diagram illustrating another example of step S21 and step S22. As exemplified in the upper left diagram of FIG. 9, one initial point is generated in the form of a sequence. In the example of the upper left diagram of FIG. 9, a sequence is generated in which “j” is arranged in order of “2, 1, 4, 3, 6, 5, 8, 7, 10, 9” when “i” is arranged in order from 1 to 10. This sequence is converted into a bit matrix as in the right diagram of FIG. 9. “1” when (i, j)=(1, 2), (2, 1), (3, 4), (4, 3), (5, 6), (6, 5), (7, 8), (8, 7), (9, 10), and (10, 9), and “0” in other cases. As in the lower left diagram, the obtained bit matrix is converted into a bit array.

Such initial points as described above are generated as many as the number determined by the setting of a user.

FIG. 6 is referred to again. Next, the evaluation unit 30 calculates an evaluation value of each initial point by using a solver (step S12). The evaluation unit 30 calculates an evaluation value for a bit array generated from a sequence. The obtained evaluation values are reflected in the evaluation value field in FIG. 8 and FIG. 9. An initial learning data group in which the initial point obtained in step S11 and the evaluation value calculated in step S12 form a set, is stored in the storing unit 10. Each learning data group includes a set of information on a sequence, information on a bit array, and evaluation values.

Next, the FMDA execution unit 40 generates a DA-recommended point, and the GA execution unit 50 generates a GA-recommended point (step S13).

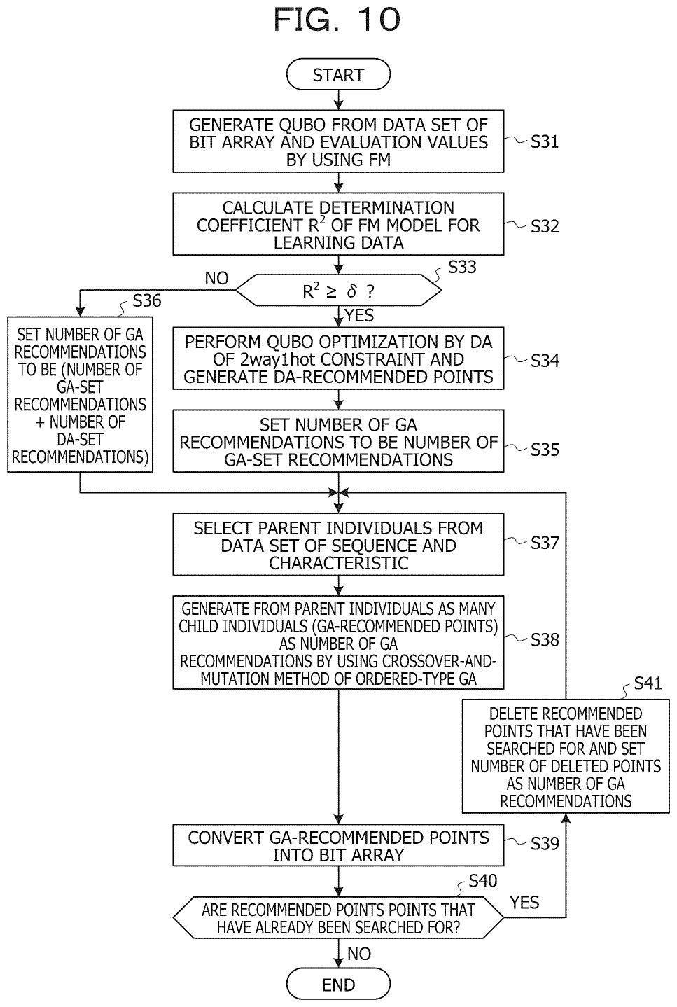

FIG. 10 is a flowchart illustrating the details of step S13. As exemplified in FIG. 10, the FMDA execution unit 40 generates a model in the QUBO format by generating FM based on the learning data group stored in the storing unit 10 (step S31). The FMDA execution unit 40 generates FM by using a bit array. Since FM is in the QUBO format, generation of FM is equivalent to generation of a model in the QUBO format. Any other machine learning model may be used as long as a model in the QUBO format may be generated.

Next, the FMDA execution unit 40 calculates determination coefficient R² of the FM model for the learning data group (step S32). Determination coefficient R² is an indicator of model accuracy, and represents that, as the determination coefficient is closer to 1, the accuracy of searching for a good solution with a high evaluation value is higher. For example, determination coefficient R² may be calculated by the following formula.

$${R}^{2} = 1 - \frac{{\sum }_{i = 1}^{n} {( {y}_{i} - \hat{y} )}^{2}}{{\sum }_{i = 1}^{n} {( {y}_{i} - \overline{y} )}^{2}}$$

In the formula, yᵢ is an actual measurement value. The following formula is a prediction value.
ŷ

The following formula is an average value of actual measurement values.
y̅

Next, the FMDA execution unit 40 determines whether determination coefficient R² is equal to or larger than threshold δ (step S33). Threshold δ is set in advance by a user. An example of threshold δ will be described. For example, threshold δ is set to about 0.8 when step S33 is executed for the first time. Preferably, the value of threshold δ is small when DA recommendation works effectively, and the value of threshold δ is large when DA recommendation does not work effectively. For example, whether DA-recommendation works effectively may be determined depending on whether a rate of determination of “Yes” in step S33 is equal to or larger than a threshold.

When “Yes” is determined in step S33, the FMDA execution unit 40 generates as many DA-recommended points as the number of DA-set recommendations by QUBO optimization by DA of the 2way1hot constraint (step S34). The number of DA-set recommendations is set in advance by a user. A DA-recommended point is a good solution (recommended point) with the best evaluation value. Alternatively, a DA-recommended point is a good solution (recommended point) with an evaluation value equal to or larger than a threshold. Alternatively, a DA-recommended point is a good solution (recommended point) with an evaluation value up to a predetermined ranking from the top. In DA of the 2way1hot constraint, a search that avoids a constraint violation may be performed by using a constraint condition at the time of selecting an inversion bit and simultaneously inverting four bits at the time of 2way1hot.

After that, the GA execution unit 50 sets the number of GA recommendations to be the number of GA-set recommendations (step S35).

When “No” is determined in step S33, the GA execution unit 50 sets the number of GA recommendations to be (the number of GA-set recommendations+the number of DA-set recommendations) (step S36). The number of GA-set recommendations is set in advance by a user. The number of GA recommendations does not have to be (the number of GA-set recommendations+the number of DA-set recommendations), and may be a number larger than the number of GA recommendations.

After the execution of step S35 or after the execution of step S36, the GA execution unit 50 selects as many parent individuals as the number of GA recommendations from the learning data group stored in the storing unit 10 (step S37). The method of selecting parent individuals is not particularly limited. For example, there is a method of randomly extracting individuals of a number exceeding the number of GA recommendations (tournament size NT) from a learning data group, and selecting as many individuals as the number of GA recommendations with high evaluation from among the individuals (tournament selection). Alternatively, as many individuals as the number of GA recommendations with the highest evaluation may be selected from a learning data group (elite selection). Tournament size NT is set in advance by a user.

Next, the GA execution unit 50 generates, from the parent individuals, as many child individuals (GA-recommended points) as the number of GA recommendations, by crossover and mutation of an order-type GA (step S38). In this case, the GA execution unit 50 uses information on a sequence included in each piece of learning data.

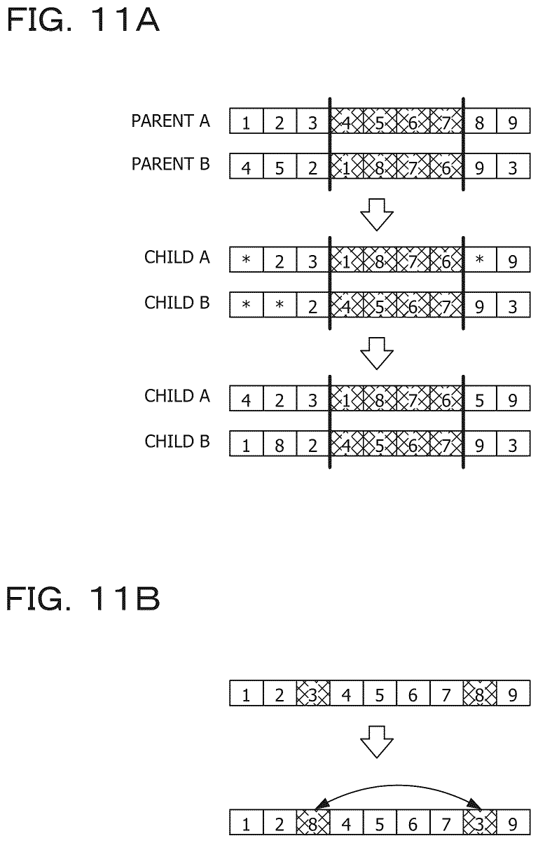

FIG. 11A is a diagram exemplifying crossover. For example, one or more elements “j” of the same “i” are set as crossover points for parent individual A and parent individual B. Next, the crossover points of parent individual A and the crossover points of parent individual B are exchanged. Next, those that do not cause a conflict with those in the crossover points are determined. In the example of FIG. 11A, “*” is added to those that do not cause a conflict. Next, the map of the exchange is referred to, and the rest is determined such that no conflict is caused. FIG. 11B is a diagram exemplifying mutation. First, two “i” are randomly selected. Next, the elements “j” of the two selected “i” are exchanged. A crossover probability and a mutation probability are set in advance by a user.

FIG. 10 is referred to again. The GA execution unit 50 converts the information on the sequence of the GA-recommended points generated in step S38 into a bit array as described with reference to FIG. 8 and FIG. 9 (step S39).

Next, the GA execution unit 50 determines whether the recommended points obtained in step S39 are points that have already been searched for (step S40).

When it is determined that the recommended points obtained in step S39 are points that have already been searched for (i.e., in a case where “Yes” is determined in step S40), recommended points that have been searched for are excluded, and the number of deleted points is set as the number of GA recommendations (step S41). After that, the processing is executed again from step S37. Accordingly, GA-recommended points may be generated by excluding the recommended points that have been searched for. When it is determined that the recommended points obtained in step S39 are not points that have already been searched for (i.e., in a case where “No” is determined in step S40), the execution of the flowchart of FIG. 10 ends.

FIG. 6 is referred to again. Next, the evaluation unit 30 calculates an evaluation value of a recommended point by using the solver (step S14). Recommended points in this case are DA-recommended points and GA-recommended points when step S36 is executed, and are GA-recommended points when step S35 is executed.

Next, the learning data update unit 60 adds an evaluation result (a recommended point and evaluation value set) to the learning data group as learning data (step S15). Each learning data group includes a set of information on a sequence, information on a bit array, and evaluation values.

Next, the learning data update unit 60 determines whether the number of pieces of learning data in the learning data group exceeds an upper limit number (step S16). An upper limit number of the number of pieces of learning data is set in advance by a user.

When “Yes” is determined in step S16, the learning data update unit 60 selects the upper limit number of pieces of learning data in descending order of evaluation value, and deletes learning data other than the selected learning data (step S17). Alternatively, the learning data update unit 60 may select learning data in which an evaluation value is equal to or larger than a predetermined value, and delete learning data other than the selected learning data.

When “No” is determined in step S16 or after the execution of step S17, the FMDA execution unit 40 determines whether the number of times of iteration has reached an upper limit (step S18). The number of times of execution of step S18 may be set as the number of times of iteration. An upper limit number of the number of times of iteration is set in advance by a user.

When “No” is determined in step S18, the processing is executed again from step S13. When “Yes” is determined in step S18, the execution of the flowchart ends.

The output unit 70 outputs a result of the processing of FIG. 6. For example, the output result is displayed by the display device 105. For example, the output unit 70 may output the contents of a learning data group and may output learning data with a high evaluation value in the learning data group as a good solution.

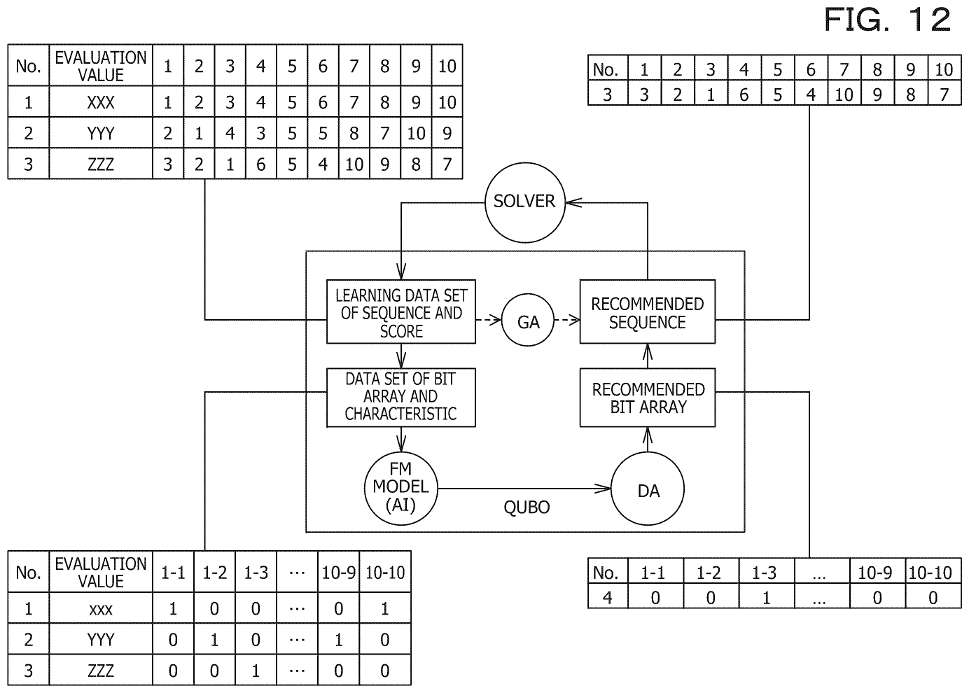

FIG. 12 is a diagram in which the processing of the present embodiment is organized. As exemplified in FIG. 12, initial points are randomly generated in the form of a sequence, and then the generated initial points are converted into a form satisfying the 2way1hot constraint by being converted into a bit array. An evaluation value is calculated for each piece of learning data. An obtained learning data set of the sequence and evaluation values is stored.

Next, QUBO is generated by machine learning as in the following formula.

$$H = {{\sum }^{N}}_{i = 1} {{\sum }^{N}}_{j = 1} {Q}_{i j} {x}_{i} {x}_{j}$$

Next, the 2way1hot constraint is set at the time of solution finding of DA, and an optimal value of an FM model (QUBO) satisfying the 2way1hot constraint is searched for. Accordingly, a DA-recommended point satisfies the 2way1hot constraint.

On the other hand, learning data is treated as a population, and recommended points are generated by using order type GA processing (selection, crossover, and mutation). Since GA-recommended points are sequence information, the GA-recommended points are converted into a bit array after generation. By processing in individual representation of a sequence, the recommended points satisfy the 2way1hot constraint.

According to the present embodiment, the number of DA-set recommendations and the number of GA-set recommendations are determined according to the accuracy of an FM model generated from a learning data group. Accordingly, both high accuracy for obtaining a good solution and reduction in the number of times of sampling may be achieved.

For example, in a case where the accuracy of an FM model generated from a learning data group is low, there is a possibility that the accuracy of searching for a good solution in DA is low. Accordingly, the number of GA recommendations is increased without performing DA recommendation. By using GA, it is possible to treat learning data as a population and generate recommended points by using GA processing. Accordingly, a region in which an evaluation value is likely to be good may be sampled in a wide range. In this case, since DA recommendation with low accuracy is not performed, as a result, a good solution may be obtained with high accuracy with a small number of times of sampling.

For example, in a case where the accuracy of an FM model generated from a learning data group is high, a good solution in an FM model may be generated by DA as a recommended point. In this case, a region in which an evaluation value is high may be actively sampled. Accordingly, the number of times of sampling for obtaining a good solution may be reduced.

From the above, according to the present embodiment, both high accuracy for obtaining a good solution and reduction in the number of times of sampling may be achieved.

In the present embodiment, a learning data group in the form satisfying the 2way1hot constraint may be generated by generating initial points in the form of a sequence. The 2way1hot constraint may be satisfied by providing a constraint satisfying the 2way1hot constraint in DA optimization. A learning data group in the form satisfying the 2way1hot constraint may be generated by using an order type GA in GA optimization. From the above, the 2way1hot constraint may be satisfied, and falling into a local solution may be reduced in optimization.

The accuracy of modeling used for sampling may be improved by updating a learning data group according to the evaluation value of each piece of learning data included in the learning data group when the number of pieces of data in the learning data group exceeds an upper limit number.

### (Simulation Result)

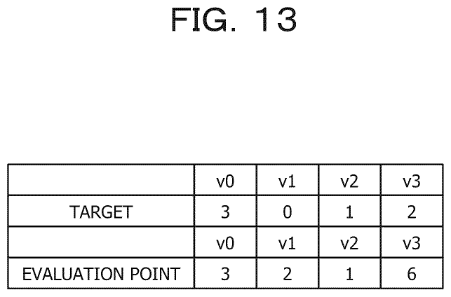

Hereinafter, description will be given for a simulation result obtained by setting a virtual problem and performing operation processing according to the above embodiment. FIG. 13 is a diagram exemplifying a test problem. In this test problem, a deviation degree between a target sequence and a solution is defined as a score. In the example of FIG. 13, target values are determined for four indices of v0, v1, v2, and v3. Among the evaluation points of v0, v1, v2, and v3 of a certain solution, there are three evaluation points different from the target value. Since this number is set as the deviation degree, score value E is 3 in the example of FIG. 13.

For this test problem, sampling was performed using two types of methods, FMDA using the penalty method and the method of the present embodiment. As common settings, the number of variables is 25 and the number of used bits is 625. By setting the number of initial points to 150, the number of initial points is made smaller than that of used bits. In FMDA using the penalty method, the following formula was applied for the test problem in FIG. 13. Nv is the number of variables, and xᵢⱼ∈{0, 1}. α=1/Nv², β=1, and C=Nv. The penalty term has a positive value in the case of a constraint violation.

$${E}^{′} = \{ \begin{matrix}E , if when 2 way 1 hot constraint is satisfied \\ α ( {\sum }_{i} {\vert {\sum }_{j} {x}_{ij} - 1 \vert}^{β} + {\sum }_{j} {\vert {\sum }_{i} {x}_{ij} - 1 \vert}^{β} ) + C , else\end{matrix}$$

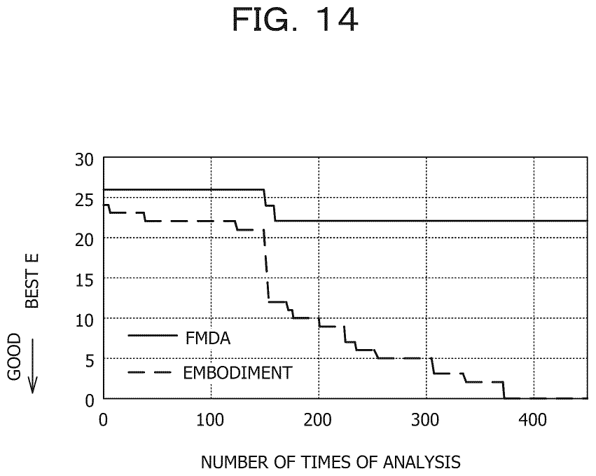

FIG. 14 is a diagram illustrating the best values found in a search. The vertical axis represents energy E in the QUBO format. Accordingly, the vertical axis indicates that a better result is obtained as the value is smaller. The number of times of analysis of the horizontal axis indicates the number of times of iteration. As illustrated in FIG. 14, it may be seen that an optimal solution may be found with a small number of times of analysis in the present embodiment.

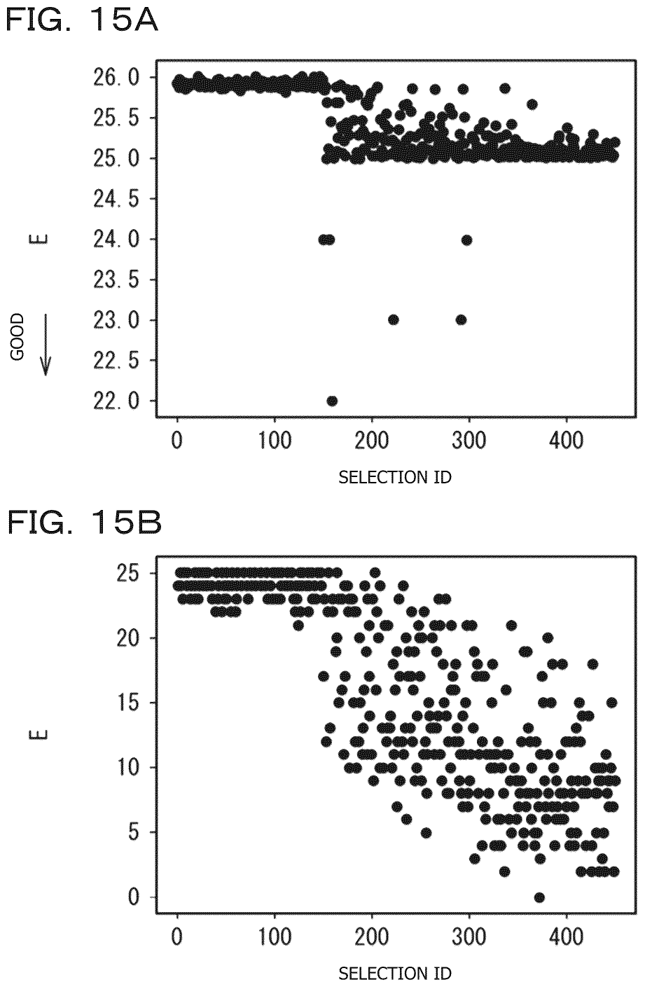

FIG. 15A is a diagram illustrating the details of a result of the method using only FM-DA. In FIG. 15A, an evaluation value (energy E) of each obtained solution is plotted. As illustrated in FIG. 15A, it may be seen that convergence to a local solution occurs in FM-DA. This is considered to be because a large number of constraint violation points are generated in the penalty method.

By contrast, FIG. 15B is a diagram illustrating the details of a result of the method of the present embodiment. As illustrated in FIG. 15B, in the present embodiment, optimization may be searched for with a small number of times of analysis. This is considered to be because a constraint violation during the search may be avoided.

In the above example, the initial point generation unit 20 is an example of an initial point generation unit that generates a plurality of types of sequences as an initial point of each piece of learning data of a learning data group. The FMDA execution unit 40 and the GA execution unit 50 are examples of an execution unit that, when a first recommended point is searched for, searches for a first recommended point after a matrix of i and j is converted into a bit array of i and j in which the value corresponding to a sequence is 1 and the other values are 0 when an index of a variable in the sequence is i and an index representing the type of a variable is j for each piece of learning data, by providing a constraint that only one of the variables of each row is 1 and only one of the variables of each column is 1 in the matrix, and when a second recommended point is searched for, applies a genetic algorithm to the form of a sequence. The learning data update unit 60 is an example of an update unit that updates a learning data group according to the evaluation value of each piece of learning data when the number of pieces of learning data in the learning data group exceeds an upper limit.

Although the embodiment of the present disclosure has been described in detail above, the present disclosure is not limited to such particular embodiment and may be variously modified and changed within the scope of the gist of the present disclosure described in claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an operation program for causing a computer to perform processing comprising:
in repeatedly executing operation processing including creating an Ising model based on a learning data group, searching for a first set number of first recommended points for the Ising model, searching for a second set number of second recommended points for the learning data group by a genetic algorithm, and adding the first recommended points and first evaluation values of the first recommended points and the second recommended points and second evaluation values of the second recommended points to the learning data group as learning data,
generating a plurality of types of a sequence as an initial point of each piece of learning data of the learning data group;
when the first recommended points are searched for, searching for the first recommended points after a matrix of i and j is converted into a bit array of i and j in which a value that corresponds to the sequence is 1 and other values are 0 when an index of a variable in the sequence is i and an index that represents a type of the variable is j for the each piece of learning data, by providing a constraint that only one of variables of each row is 1 and only one of variables of each column is 1 in the matrix; and
when the second recommended points are searched for, applying the genetic algorithm to a form of the sequence.

2. The non-transitory computer-readable recording medium according to claim 1, the processing further comprising:
searching for other of the second recommended points when the second recommended points that are searched for are included in the learning data group.

3. The non-transitory computer-readable recording medium according to claim 1, the processing further comprising:
determining the first set number and the second set number according to an accuracy of the Ising model.

4. The non-transitory computer-readable recording medium according to claim 3, the processing further comprising:
searching for the second recommended points by increasing the second set number without searching for the first recommended points when an accuracy of the Ising model is less than a threshold.

5. The non-transitory computer-readable recording medium according to claim 3, the processing further comprising:
searching for the second recommended points by setting a sum of the first set number and the second set number to the second set number, without searching for the first recommended points, when an accuracy of the Ising model is less than a threshold.

6. The non-transitory computer-readable recording medium according to claim 3, the processing further comprising:
searching for the first recommended points and the second recommended points without changing the first set number and the second set number when an accuracy of the Ising model is equal to or more than a threshold.

7. The non-transitory computer-readable recording medium according to claim 1, wherein
an upper limit is provided for a number of pieces of the learning data in the learning data group, and
the processing further comprises
updating the learning data group according to an evaluation value of each piece of the learning data when a number of pieces of the learning data in the learning data group exceeds the upper limit.

8. The non-transitory computer-readable recording medium according to claim 7, the processing further comprising:
deleting other pieces of the learning data while leaving the upper limit number of pieces of the learning data in the learning data group in descending order of evaluation value when a number of pieces of the learning data in the learning data group exceeds the upper limit.

9. An operation method implemented by a computer, the operation method comprising:
in repeatedly executing operation processing including creating an Ising model based on a learning data group, searching for a first set number of first recommended points for the Ising model, searching for a second set number of second recommended points for the learning data group by a genetic algorithm, and adding the first recommended points and first evaluation values of the first recommended points and the second recommended points and second evaluation values of the second recommended points to the learning data group as learning data,
generating a plurality of types of a sequence as an initial point of each piece of learning data of the learning data group;
when the first recommended points are searched for, searching for the first recommended points after a matrix of i and j is converted into a bit array of i and j in which a value that corresponds to the sequence is 1 and other values are 0 when an index of a variable in the sequence is i and an index that represents a type of the variable is j for the each piece of learning data, by providing a constraint that only one of variables of each row is 1 and only one of variables of each column is 1 in the matrix; and
when the second recommended points are searched for, applying the genetic algorithm to a form of the sequence.

10. An information processing apparatus comprising:
a memory; and
a processor circuit coupled to the memory, the processor circuit being configured to perform processing comprising:
in repeatedly executing operation processing including creating an Ising model based on a learning data group, searching for a first set number of first recommended points for the Ising model, searching for a second set number of second recommended points for the learning data group by a genetic algorithm, and adding the first recommended points and first evaluation values of the first recommended points and the second recommended points and second evaluation values of the second recommended points to the learning data group as learning data,
generating a plurality of types of a sequence as an initial point of each piece of learning data of the learning data group;
when the first recommended points are searched for, searching for the first recommended points after a matrix of i and j is converted into a bit array of i and j in which a value that corresponds to the sequence is 1 and other values are 0 when an index of a variable in the sequence is i and an index that represents a type of the variable is j for the each piece of learning data, by providing a constraint that only one of variables of each row is 1 and only one of variables of each column is 1 in the matrix; and
when the second recommended points are searched for, applying the genetic algorithm to a form of the sequence.
